(19) United States
(12) Patent Application Publication
(10) Pub. No.: US 2018/0370357 A1
(43) Pub. Date: Dec. 27, 2018

(54) VEHICLE CONTROL DEVICE

(71) Applicant: Mazda Motor Corporation, Hiroshima (JP)

(72) Inventors: Sho Yabunaka, Hatsukaichi-shi (JP); Yusaku Takeda, Hiroshima-shi (JP); Masatoshi Takayama, Hiroshima-shi (JP)

(21) Appl. No.: 15/971,823

(22) Filed: May 4, 2018

(30) Foreign Application Priority Data
Jun. 22, 2017 (JP) 2017-121866

(51) Int. Cl. B60K 26/02

(52) U.S. Cl. CPC B60K 26/02; B60Y 2300/18008; B60K 2026/026

(57) ABSTRACT

A vehicle control device is provided, which includes a depression amount detector configured to detect a depression amount of an accelerator pedal, a processor configured to execute a reaction force setting module to set a reaction force of the accelerator pedal based on a detection result of the depression amount detector, a reaction force applying part configured to apply the reaction force to the accelerator pedal based on a setting result of the reaction force setting module, and an operation amount detector configured to detect an operation amount of a driver's foot on the accelerator pedal. The reaction force setting module sets a reaction force value of the accelerator pedal for a depression characteristic and a counter-depression characteristic. The reaction force setting module includes a reaction force correcting module configured to reduce the reaction force value of the counter-depression characteristic as the detected operation amount increases.

### TECHNICAL FIELD

The present disclosure relates a vehicle control device, which controls a reaction force value of an accelerator pedal according to a vehicle driver's muscle activity.

### BACKGROUND OF THE DISCLOSURE

Conventionally, in a vehicle equipped with a drive-by-wire type engine, since an accelerator pedal and an output control device of a throttle valve, a fuel injection device, etc. are not connected to each other by a cable, a reaction force at a value corresponding to a depression amount of the accelerator pedal is applied to the driver by an electric actuator.

Since the depression amount and the reaction force value are set to be substantially proportional, the driver generally confirms the depression amount of the accelerator pedal by the reaction force value applied from the accelerator pedal. Therefore, a reaction force control device is proposed, in which a depression operation of an accelerator pedal by a vehicle driver is induced according to the driver's preference and a traveling environment by changing a reaction force value of the accelerator pedal.

JP5293784B discloses an operation assisting device which dynamically generates driving intention sequences of a plurality of virtual drivers in a given period of time in the past up to a current time point, estimates a driving intention of an actual driver by calculating, for each driving intention sequence, a driving operation amount sequence approximation degree expressing a degree of sequence approximation of a driving operation amount of the virtual driver and a driving operation amount of the actual driver, and comparing the driving operation amount sequence approximation degrees, and estimates a state of the actual driver based on the estimated driving intention.

During the depression operation of the accelerator pedal, for as long as the time taken to infer the intent of the driver to change lanes, the reaction force instruction value for the accelerator pedal is sharply reduced.

Further, an art for setting a reaction force characteristic of an accelerator pedal which takes into consideration a human perception characteristic is proposed by the present applicant.

JP2016-000581A discloses an accelerator pedal control device for a vehicle, which includes a depressing speed detector which detects a depressing speed of an accelerator pedal, and a reaction force setting module having a three-dimensional map defined by a depression amount of the accelerator pedal, the depressing speed of the accelerator pedal, and a value of reaction force applied to a vehicle driver. The reaction force setting module sets a reaction force characteristic so that the reaction force value of the accelerator pedal becomes lower when the depressing speed is high than when the depressing speed is low.

As a result, the reaction force characteristic suitable for a traveling environment and a driving intention is set while reducing the driver's burden and discomfort.

Depression and counter-depression operations of the accelerator pedal by the driver can be regarded, in view of muscle activity, as plantar flexion and dorsiflexion motions at a foot joint, respectively.

As illustrated in FIG. 9, an anterior tibial muscle p, a soleus muscle q, a gastrocnemius muscle r, etc. are mainly involved in the operation of the accelerator pedal by the foot joint.

The anterior tibial muscle p is a single (one) articular muscle for performing the dorsiflexion motion of the foot joint, and the soleus muscle q is a single articular muscle for performing the plantar flexion motion of the foot joint. The gastrocnemius muscle r is a biarticular muscle for performing the plantar flexion motion of the foot joint and a bending motion of a knee joint. Among these skeletal muscles, the single articular muscle has an antigravity ability which depends on a mechanical force ratio and lifts the body against gravity, and the biarticular muscle has a thrust ability which reduces a mechanical energy consumption and performs a directional control of external force, i.e., thrusts the body to move in a specific direction.

Further, the skeletal muscles are classified into an agonist muscle which causes a joint motion by muscle contraction caused by an exercise action and an antagonist muscle which works in reverse with the agonist muscle as a pair.

Therefore, in the depression operation, the agonist muscle becomes the soleus muscle q and the antagonist muscle becomes the anterior tibial muscle p, and an operation mainly using the soleus muscle q as the agonist muscle is performed. On the other hand, in the counter-depression operation, an operation mainly using the anterior tibial muscle p as the antagonist muscle is performed.

The operation of the accelerator pedal by the driver includes a sharp acceleration (or sharp deceleration) operation in which the accelerator pedal is sharply controlled from an initial position to a target position, and a gentle acceleration (or gentle deceleration) operation in which the accelerator pedal is finely adjusted in a given range, according to a driving scene.

On the other hand, due to characteristics of the muscle, in the sharp acceleration operation, since the driver makes a significant motion with a high load (depression or counter-depression), the control perceptibility recognized by the driver is enhanced by performing the operation mainly with a biarticular muscle, and a realistic sensation can be obtained. Further, in the gentle acceleration operation, since the driver makes a small motion at high accuracy (fine adjustment), the ease of operation is improved by performing the operation mainly with the single articular muscle, and the operability can be obtained.

Therefore, in order to improve the realistic sensation and operability, so-called operation feeling, in the sharp acceleration operation, the biarticular muscle is preferably caused to function as the agonist muscle to set its contribution ratio higher than that of the single articular muscle, and in the gentle acceleration operation, the single articular muscle is preferably caused to function as the agonist muscle to set its contribution ratio higher than that of the biarticular muscle.

However, in the gentle acceleration/deceleration operation, a sufficient operation feeling of the accelerator pedal may not be secured even when the single articular muscle is caused to function as the agonist muscle to set its contribution ratio higher than that of the biarticular muscle.

In the depression operation for the gentle acceleration/deceleration operation which includes the fine adjustment of the accelerator pedal, the soleus muscle q functions as the agonist muscle and the anterior tibial muscle p functions as the antagonist muscle. In the counter-depression operation, an operation mainly using the anterior tibial muscle p which is the antagonist muscle is performed so as to cancel the depression operation.

That is, in the gentle acceleration/deceleration operation in which the accelerator pedal is finely adjusted, both the agonist muscle and the antagonist muscle are single articular muscles, and merely adjusting the contribution ratios of the single articular muscle and the biarticular muscle does not achieve an easy, smooth switch of the muscle activity from the agonist to the antagonist in shifting from the depression operation to the counter-depression operation, and the driver cannot achieve the sufficient operation feeling.

### SUMMARY OF THE DISCLOSURE

The purpose of the present disclosure is to provide a vehicle control device, which is capable of securing sufficient operability for a vehicle driver in terms of sensation, regardless of the type of muscle to be mainly used in the operation.

A vehicle control device according to one aspect of the present disclosure includes a depression amount detector configured to detect a depression amount of an accelerator pedal, a processor electrically connected to the depression amount detector and configured to execute a reaction force setting module to set a reaction force of the accelerator pedal based on a detection result of the depression amount detector, a reaction force applying part electrically connected to the processor and configured to apply the reaction force to the accelerator pedal based on a setting result of the reaction force setting module, and an operation amount detector electrically connected to the reaction force applying part and configured to detect an operation amount of a vehicle driver's foot on the accelerator pedal. The reaction force setting module sets a reaction force value of the accelerator pedal for a depression characteristic and a counter-depression characteristic, respectively, the depression characteristic being configured by a correlative relationship between the depression amount and the reaction force value of the accelerator pedal from a start of a depression operation of the accelerator pedal until an end of the depression operation, the counter-depression characteristic being configured by a correlative relationship between the depression amount and the reaction force value of the accelerator pedal from a start of a counter-depression operation of the accelerator pedal until an end of the counter-depression operation. The reaction force setting module includes a reaction force correcting module configured to reduce the reaction force value of the counter-depression characteristic as the operation amount detected by the operation amount detector increases.

In this vehicle control device, since the reaction force correcting module reduces the reaction force value of the counter-depression characteristic as the operation amount detected by the operation amount detector increases, within a fine adjustment range of the accelerator pedal, the counter-depression characteristic related to the counter-depression operation is set so that a main muscle activity is smoothly switched from an agonist muscle to an antagonist muscle, and operability of the accelerator pedal is secured.

The reaction force correcting module may correct the counter-depression characteristic by reduction.

According to this configuration, by increasing a hysteresis between the depression characteristic and the counter-depression characteristic, wobbling of a vehicle driver's foot is prevented, and by reducing the counter-depression characteristic, the reaction force acting on the antagonistic muscle is reduced and the operability by the antagonistic muscle is secured.

The operation amount detector may detect the operation amount of the driver's foot by using a depressing speed of the accelerator pedal as a parameter.

According to this configuration, the muscle mainly used in the operation and its operation amount may be detected using the existing accelerator pedal.

The operation amount detector may include a contact pressure detector configured to detect a contact area of the driver's foot on the accelerator pedal and detect the operation amount of the driver's foot by using the contact area as a parameter.

According to this configuration, the kind of the muscle mainly used in the operation and its operation amount are accurately detected.

A vehicle control device according to another aspect of the present disclosure includes a processor configured to execute a reaction force setting module to set a reaction force value of an accelerator pedal based on a reference control map having a depression characteristic and a counter-depression characteristic and in which a correlative relationship between a depression amount of the accelerator pedal and the reaction force value is set, and an operation amount detector configured to detect an operation amount of a vehicle driver's foot by using a depressing speed of the accelerator pedal as a parameter. The reaction force setting module changes the counter-depression characteristic of the reference control map in association with the depressing speed used by the operation amount detector.

In this vehicle control device, since the reaction force setting module changes the counter-depression characteristic of the reference control map in association with the depressing speed used by the operation amount detector, within a fine adjustment range of the accelerator pedal, the counter-depression characteristic related to the counter-depression operation is set so that a main muscle activity is smoothly switched from an agonist muscle to an antagonist muscle, and operability of the accelerator pedal is secured. This configuration is particularly effective in improving the operability when the depressing speed is high despite the driver's depression amount on the accelerator pedal being small.

### BRIEF DESCRIPTION OF THE DRAWINGS

FIG. 1 is a block diagram of a vehicle control device according to a first embodiment.

FIG. 2 is a schematic view of an accelerator pedal and a reaction force applying part.

FIG. 3 is a chart illustrating a basic control map.

FIG. 4 is a chart illustrating a corrected control map for gentle acceleration/deceleration operation.

FIG. 5 is a chart illustrating a corrected control map for sharp acceleration/deceleration operation.

FIG. 6 is a flowchart illustrating a processing procedure of the control device.

FIG. 7 is a view illustrating a modification of an operation amount detector.

FIG. 8 is a view illustrating another modification of the operation amount detector.

FIG. 9 is a view of a skeletal muscle when operating the accelerator pedal.

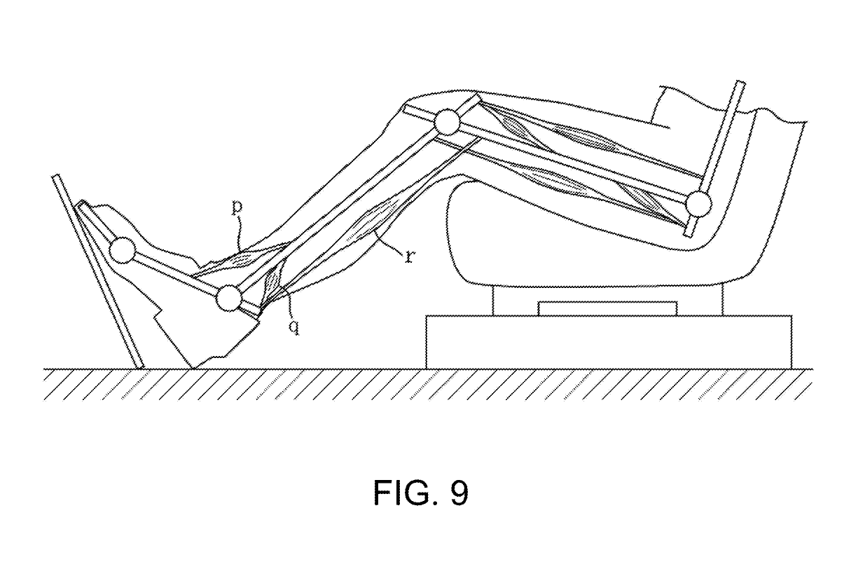

### DETAILED DESCRIPTION OF THE DISCLOSURE

Hereinafter, embodiments of the present disclosure are described in detail with reference to the accompanying drawings.

The following description exemplifies a case where the present disclosure is applied to a vehicle control device and is not to limit the present disclosure, an application thereof, or a usage thereof.

### First Embodiment

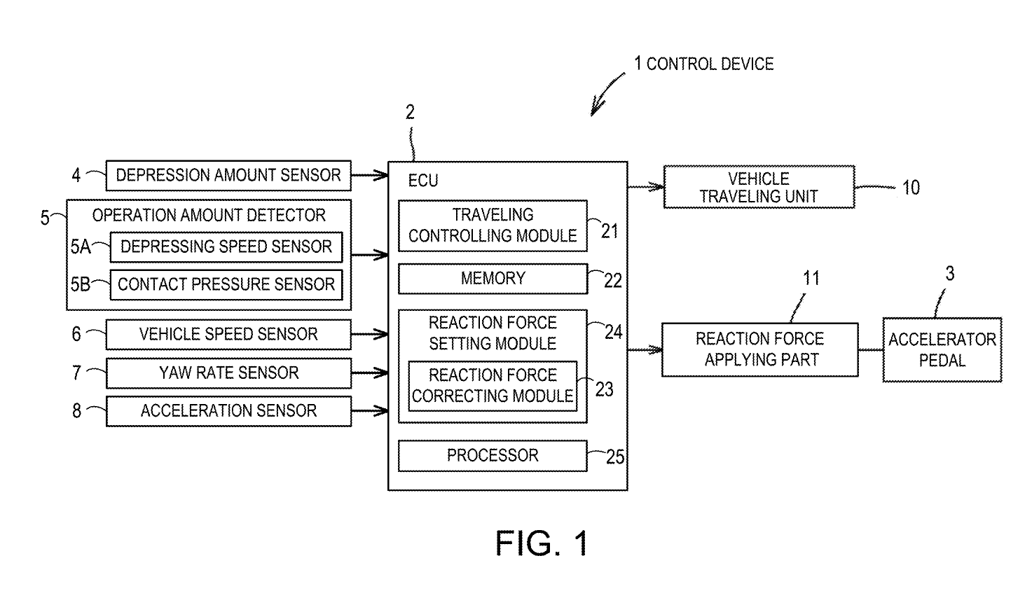

Hereinafter, a first embodiment of the present disclosure is described with reference to FIGS. 1 to 6.

A vehicle control device 1 controls a reaction force value of an accelerator pedal 3 according to a muscle activity of a vehicle driver so as to provide the driver a realistic feeling in operation regardless of a muscle mainly used in the operation.

As illustrated in FIG. 1, the control device 1 includes an ECU (Electronic Control Unit) 2. The ECU 2 is an electronic control unit comprised of a processor 25 (i.e., a central processing unit (CPU)) and memory 22 (i.e., ROM(s) and RAM(s)), and performs various arithmetic processes by loading an application program (e.g., a software module) stored in the ROM into the RAM and executes it by the processor 25.

The ECU 2 is electrically connected to a depression amount sensor 4 (depression amount detector) which detects a depression/counter-depression amount (hereinafter referred to as the depression amount) “s” of the accelerator pedal 3, a depressing speed sensor 5A which detects a depressing speed V of the accelerator pedal 3, a vehicle speed sensor 6 which detects a traveling speed of the vehicle, a yaw rate sensor 7 which detects a yaw rate acting on the vehicle, an acceleration sensor 8 which detects an acceleration of the vehicle in traveling, a contact pressure sensor 5B (contact pressure detector), etc. The depressing speed sensor 5A and the contact pressure sensor 5B constitute an operation amount detector 5 which indirectly detects an operation amount of the foot of the driver on the accelerator pedal 3 (the kind of muscle mainly used in the operation) with the depressing speed V of the accelerator pedal 3 as a parameter. Therefore, regardless of the depression amount s, when the depressing speed V is high, the operation amount of the driver's foot is determined to be large, and when the depressing speed V is low, the operation amount of the driver's foot is determined to be small.

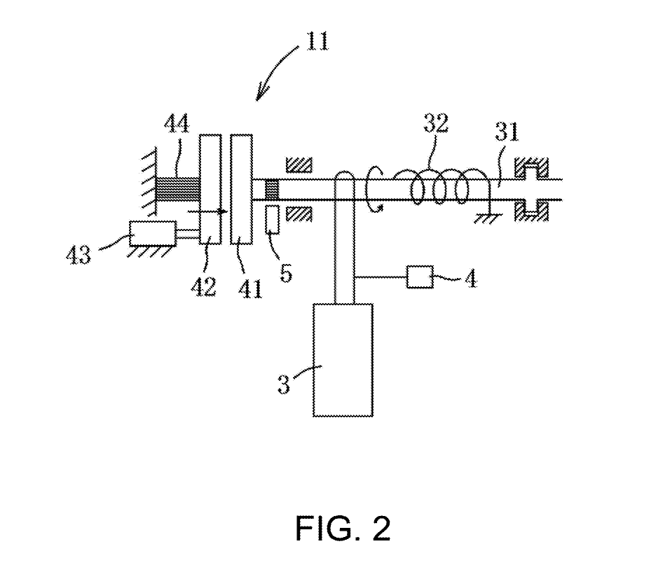

As illustrated in FIG. 2, the accelerator pedal 3 is held rotatably to the vehicle body, and a depression operation thereof triggers an input of the driver's intention to increase/decrease an engine output.

The depression amount sensor 4 is provided to the accelerator pedal 3 or a rotational shaft 31 and detects a depression stroke of the accelerator pedal 3, i.e., the depression amount s based on a rotation amount thereof. The depression amount s of the accelerator pedal 3 detected by the depression amount sensor 4 is outputted to the ECU 2. Note that when a pedaling force caused by the depression by the driver is not applied, the accelerator pedal 3 is biased to return to an initial position at which the depression amount s is zero, by a return spring 32 connected to the accelerator pedal 3.

The depressing speed sensor 5A is provided to the rotational shaft 31 of the accelerator pedal 3, and detects the depressing speed V of the accelerator pedal 3 based on a rotational speed thereof. The depressing speed V of the accelerator pedal 3 detected by the depressing speed sensor 5A is outputted to the ECU 2.

The vehicle speed sensor 6, the yaw rate sensor 7, and the acceleration sensor 8 output their respective detection results to the ECU 2.

A vehicle traveling unit 10 is a driving mechanism and a steering mechanism which execute a traveling control of the vehicle.

The vehicle traveling unit 10 includes an engine controlling module, a steering actuator, a brake actuator, a gear shift actuator (none of them are illustrated), etc.

The vehicle traveling unit 10 executes a traveling control of the vehicle based on an output signal from the ECU 2.

As illustrated in FIG. 2, a reaction force applying part 11 includes first and second frictional members 41 and 42, an electromagnetic actuator 43, etc.

The first frictional member 41 is fixedly attached to one end of the rotational shaft 31, and the second frictional member 42 is disposed facing the first frictional member 41. The second frictional member 42 is held by a holding shaft 44 disposed in an extension of an axis of the rotational shaft 31 to be non-rotatable but relatively movable thereto in its axial directions.

The actuator 43 is able to change a positional relationship of the first and second frictional members 41 and 42 between a pressed state and a separated state by adjusting the pressing force at the time of pressuring.

Next, the ECU 2 will be described.

As illustrated in FIG. 1, the ECU 2 includes a traveling controlling module 21, the memory 22, a reaction force correcting module 23 as part of or separately from a reaction force setting module 24, and the processor 25. The software modules are stored in the memory 22 and executable by the processor 25 to perform their respective functions.

The traveling controlling module 21 controls the output of the engine based on the depression amount s of the accelerator pedal 3 and the vehicle speed detected by the vehicle speed sensor 6, and selects a gear ratio of a transmission based on a vehicle traveling state and an operating state of the engine.

The output of the engine decelerated by the transmission is transmitted to drive wheels via a drive shaft (not illustrated).

The memory 22 stores in advance a reference control map F (F-S characteristic) defined by the depression amount s of the accelerator pedal 3 by the driver, the depressing speed V, and a reaction force f corresponding to a physical reaction force value acting on the driver from the accelerator pedal 3.

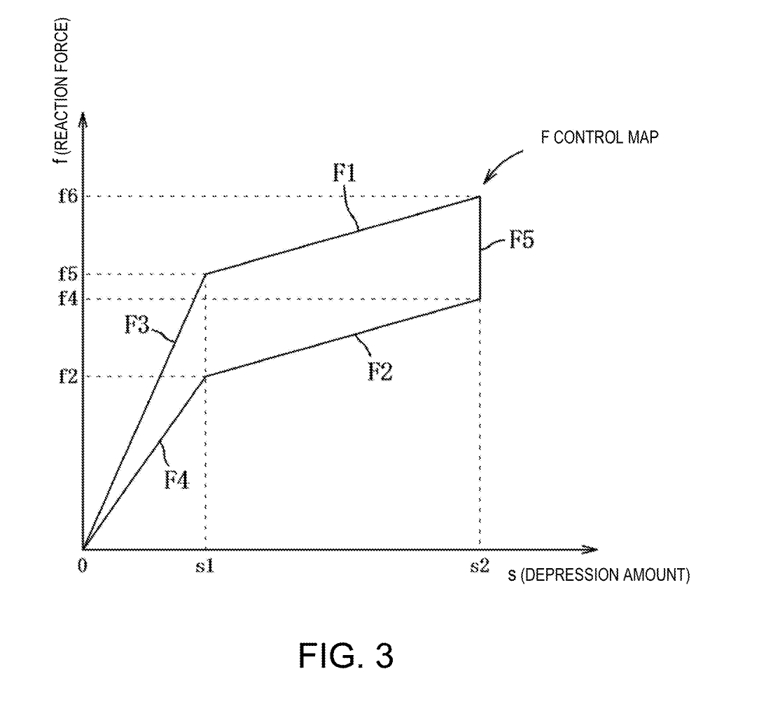

As illustrated in FIG. 3, the reference control map F includes an s axis (horizontal axis) corresponding to the depression amount s (s1 and s2) of the accelerator pedal 3 and an f axis (vertical axis) corresponding to the reaction force f (f2, f4, f5, and f6) applied to the driver via the accelerator pedal 3.

This reference control map F is formed for a standard driver, and in a given operation of the accelerator pedal 3 by this driver, i.e., depression and counter-depression operations (plantar flexion and dorsiflexion motions of a foot joint), a precondition is set in which a biarticular muscle (e.g., a gastrocnemius muscle) and a single articular muscle (e.g., an anterior tibial muscle, a soleus muscle, etc.) are moved in a given balance range (e.g., a contribution ratio of the biarticular muscle is from 40% to less than 60%).

In the reference control map F, a depression-side characteristic is constituted by an initial characteristic F3 from an origin to a depression amount s1 (reaction force f5) and a depression characteristic F1 from the depression amount s1 to a largest depression amount s2 (reaction force f6). The depression characteristic F1 may be expressed by a linear function proportional to the depression amount s, and the reaction force f6 is set larger than the reaction force f5.

Further, a counter-depression-side characteristic corresponding to a cancelling operation of the depression operation is constituted by a counter-depression characteristic F2 from the largest depression amount s2 (reaction force f4) to the initial depression amount s1 (reaction force f2) and a terminal counter-depression characteristic F4 from the depression amount s1 to the origin. The counter-depression characteristic F2 is set substantially parallel to the depression characteristic F1, and the reaction force f4 is set larger than the reaction force f2.

A separated distance between the depression characteristic F1 and the counter-depression characteristic F2 corresponds to a hysteresis F5 of the reference control map F.

Next, the reaction force correcting module 23 will be described.

When the operation stroke of the accelerator pedal 3 is small, in other words, in a gentle acceleration/deceleration operation in which a muscle mainly used in the operation by the driver is the single articular muscle (e.g., the anterior tibial muscle, the soleus muscle, etc.), if the operation amount s by the driver's foot on the accelerator pedal 3 is large, the reaction force correcting module 23 sets a control map FA obtained from correcting the reference control map F by increasing the hysteresis F5.

Here, the gentle acceleration/deceleration operation is, in view of driver's intention, an operation aiming for traveling at a substantially constant speed and, in view of a behavior of the vehicle V, a temporal transition traveling including a slight change of, for example, 30 km/h to 40 km/h or 40 km/h to 30 km/h within a short period of time.

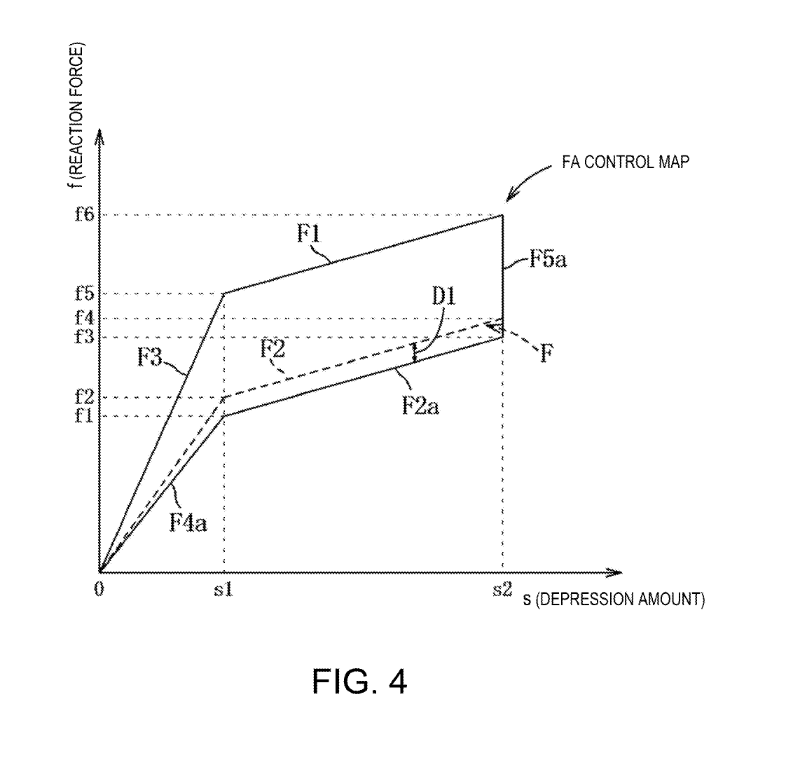

As illustrated in FIG. 4, if the depressing speed V is high in the gentle acceleration/deceleration operation, the reaction force correcting module 23 reduces the counter-depression characteristic F2 by a correction amount D1 to correct it to a counter-depression characteristic F2a.

The correction amount D1 is set to be in proportion to the depressing speed V. Further, a straight line connecting a lowest value of the counter-depression characteristic F2a to the origin is set as a terminal counter-depression characteristic F4a and a straight line connecting a highest value of the depression characteristic F1 to a highest value of the counter-depression characteristic F2a is set as a hysteresis F5a (F5+D1).

Note that the respective reaction forces have a relationship of f1<f2<f3<f4<f5<f6.

Moreover, when the operation stroke of the accelerator pedal 3 is large, in other words, in a sharp acceleration/deceleration operation in which a muscle mainly used in the operation by the driver is the biarticular muscle (e.g., the gastrocnemius muscle etc.), if the operation amount s by the driver's foot on the accelerator pedal 3 is large, the reaction force correcting module 23 sets a control map FB obtained from correcting the reference control map F by increasing the depression characteristic F1 and the counter-depression characteristic F2 to be larger than when the operation amount s is small.

Here, the sharp acceleration/deceleration operation is, in view of driver's intention, an operation aiming for traveling at an increasing or decreasing speed and, in view the behavior of the vehicle V, a long-term stable traveling including acceleration or deceleration of, for example, 0 km/h to 30 km/h, 50 km/h to 100 km/h, or 30 km/h to 0 km/h which requires a certain period of time. Note that a medium acceleration/deceleration operation corresponding to a more significant operation than the fine adjustment in the gentle acceleration/deceleration is treated as a part of the sharp acceleration/deceleration operation.

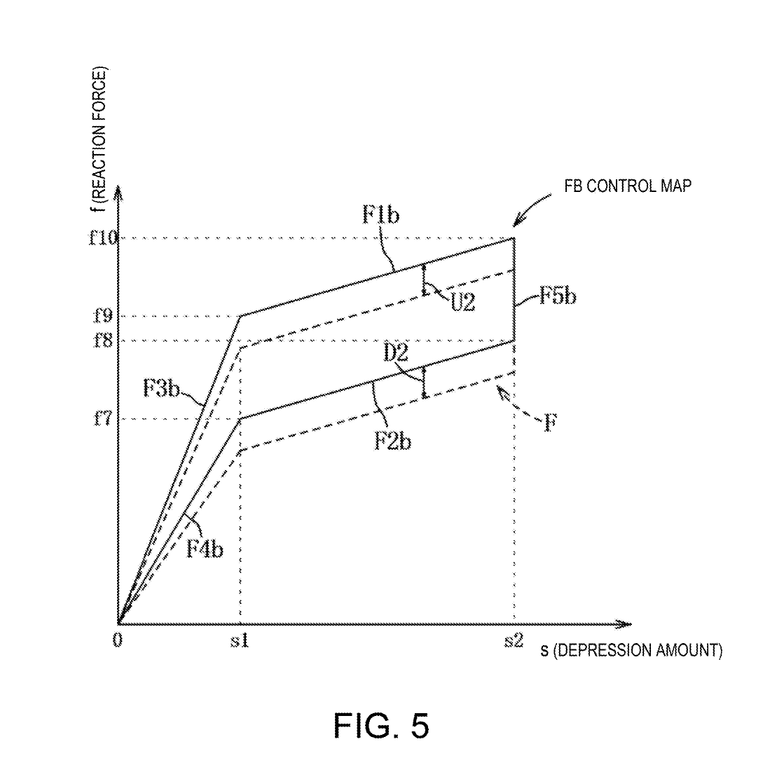

As illustrated in FIG. 5, if the depressing speed V is high in the sharp acceleration/deceleration operation, the reaction force correcting module 23 increases the depression characteristic F1 by a correction amount U2 to correct it to a depression characteristic F1b, and increases the counter-depression characteristic F2 by a correction amount D2 to correct it to a counter-depression characteristic F2b. The correction amounts U2 and D2 are set to be in proportion to the depressing speed V. Further, a straight line connecting a lowest value of the depression characteristic F1b to the origin is set as an initial depression characteristic F3b, a straight line connecting a lowest value of the counter-depression characteristic F2b is set as a terminal counter-depression characteristic F4b, and a straight line connecting a highest value of the depression characteristic F1b to a highest value of the counter-depression characteristic F2b is set as a hysteresis F5b (F5).

In this embodiment, in order to prevent the driver from feeling discomfort, the correction amounts U2 and D2 are set to be the same at the same depressing speed V in the sharp acceleration/deceleration operation so as to enhance the control perceptibility. Therefore, a relationship of D1<D2 is satisfied at the same depressing speed V, and the respective reaction forces have a relationship of f2<f7, f4<f8, f5<f9, f6<f10.

Next, the reaction force setting module 24 will be described.

The reaction force setting module 24 outputs an instruction signal related to the reaction force f based on the F-S characteristic.

For example, the reaction force f corresponding to the depression amount s is read by using the control map FA in the gentle acceleration/deceleration operation, the control map FB in the sharp acceleration/deceleration operation, the reference control map F in neither the gentle acceleration/deceleration operation nor the sharp acceleration/deceleration operation, and the read reaction force f is outputted as an operation reaction force f of the accelerator pedal 3.

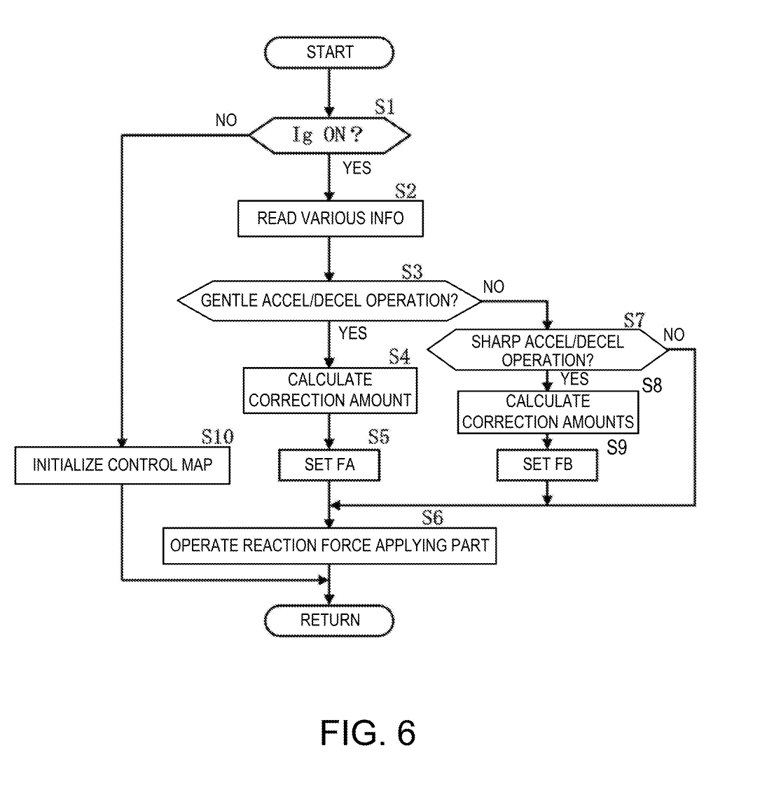

Next, a control processing procedure of the control device 1 will be described with reference to the flowchart of FIG. 6.

Note that Si (i=1, 2, . . . ) indicates a step for each processing.

As illustrated in the flowchart of FIG. 6, first at S1, whether an ignition switch (Ig) is turned on is determined.

As a result of the determination at S1, if the ignition switch is turned on, the information inputted from the various sensors 4 to 8 is read (S2), and the process proceeds to S3.

If the ignition switch is turned off as a result of the determination at S1, the control map currently used is initialized to the reference control map F (S10), and the process returns.

At S3, whether the driver performs the gentle acceleration/deceleration operation is determined.

If the driver performs the gentle acceleration/deceleration operation as a result of the determination at S3, the process proceeds to S4 at which the correction amount D1 proportional to the depressing speed V is calculated.

Next at S5, the control map FA comprised of the depression characteristic F1, the counter-depression characteristic F2a which is the counter-depression characteristic F2 reduced by the correction amount D1, the initial depression characteristic F3, the terminal counter-depression characteristic F4a, and the hysteresis F5a is set, and the process proceeds to S6.

At S6, the reaction force applying part 11 is operated based on the corrected control map FA and the process returns.

If the driver does not perform the gentle acceleration/deceleration operation as the result of the determination at S3, the process proceeds to S7 at which whether the driver performs the sharp acceleration/deceleration operation is determined.

If the driver performs the sharp acceleration/deceleration operation as a result of the determination at S7, the process proceeds to S8 at which the correction amount U2 proportional to the depressing speed V and the correction amount D2 which has the same value as the correction amount U2 are calculated.

Next at S9, the control map FB comprised of the depression characteristic F1b which is the depression characteristic F1 increased by the correction amount U2, the counter-depression characteristic F2b which is the counter-depression characteristic F2 increased by the correction amount D2, the initial depression characteristic F3b, the terminal counter-depression characteristic F4b, and the hysteresis F5b is set, then the process proceeds to S6 to operate the reaction force applying part 11 based on the corrected control map FB.

If the driver does not perform the sharp acceleration/deceleration operation as the result of the determination at S7, the process proceeds to S6 to operate the reaction force applying part 11 based on the reference control map F.

Next, the operations and effects of the vehicle control device 1 will be described.

According to the control device 1, since the reaction force setting module 24 changes the counter-depression characteristic F2 of the reference control map F in association with the operation amount of the driver detected by the depressing speed sensor 5A, within a fine adjustment range of the accelerator pedal 3, the counter-depression characteristic F2a related to the counter-depression operation may be set so that the main muscle activity is smoothly switched from the agonist muscle to the antagonist muscle, and operability of the accelerator pedal 3 is secured.

Since the reaction force setting module 24 corrects the counter-depression characteristic F2 of the reference control map F by reducing it, by increasing the hysteresis F5a between the depression characteristic F1 and the counter-depression characteristic F2a, wobbling of the driver's foot is prevented and, by reducing the counter-depression characteristic F2a, the reaction force f acting on the antagonistic muscle is reduced and the operability by the antagonistic muscle is secured.

Since the operation amount detector 5 detects the operation amount of the driver's foot by having the depressing speed V of the accelerator pedal 3 as the parameter, the muscle mainly used in the operation and its operation amount may be detected using the existing depressing speed sensor 5A.

Next, modifications in which the above embodiment is partially modified will be described. (1) Although in the above embodiment, the example is described in which the operation amount of the driver's foot is detected by having the depressing speed V of the accelerator pedal 3 as the parameter in order to improve the operability when the depressing speed V is high despite the driver's depression amount s on the accelerator pedal 3 being small, the operation amount of the driver's foot may be detected by using a contact area of the foot on the accelerator pedal 3 as the parameter.

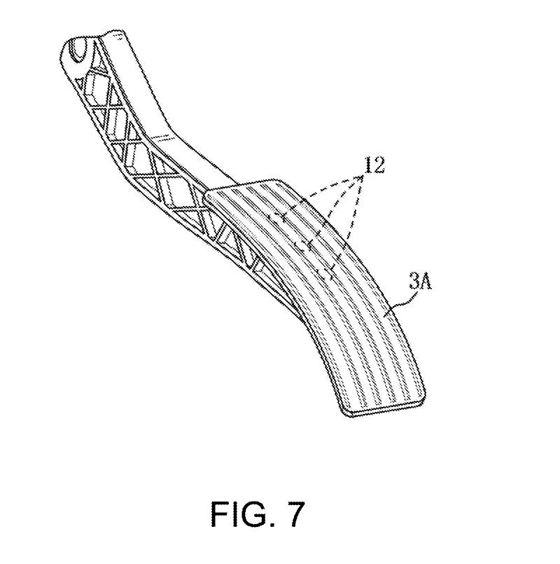

For example, as illustrated in FIG. 7, a plurality of piezoelectric elements 12 are embedded in an accelerator pedal 3A.

The plurality of piezoelectric elements 12 are arranged at an even interval in a vertical direction. A generation of voltage is detected for each piezoelectric element 12 and the contact area of the driver's foot is obtained based on the detected number of piezoelectric elements 12.

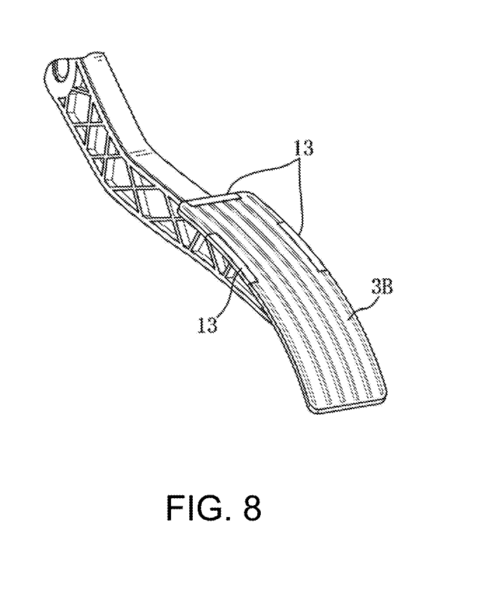

In another example, as illustrated in FIG. 8, three strain gauges 13 are disposed on an accelerator pedal 3B.

These strain gauges 13 are disposed at an upper end portion and both left and right end portions of the accelerator pedal 3B. The contact area of the driver's foot is obtained through straining by the driver's foot, measured by the strain gauges 13.

As a result, the kind of muscle mainly used in the operation and its operation amount are accurately detected.

(2) Although in the above embodiment, the example in which, in the gentle acceleration/deceleration operation, the correction amount U1 of the depression characteristic F1 and the correction amount D1 of the counter-depression characteristic F2 of the reference control map F are set to be equal is described, the increase-correction amount U1 and the decrease-correction amount D1 may be set to different values (U1<D1 or D1<U1).

Further, although the example in which, in the sharp acceleration/deceleration operation, the correction amount U2 of the depression characteristic F1 and the correction amount D2 of the counter-depression characteristic F2 of the reference control map F are set to be equal is described, the increase-correction amount U2 and the increase-correction amount D2 may be set to different values (U2<D2 or D2<U2).

(3) Although in the above embodiment the example in which the depression and counter-depression characteristics of the control map are formed by the linear function proportional to the depression amount is described, being linear is not essential, and it may be formed in a horizontally convex/concave curved shape.

(4) Additionally, those skilled in the art can implement the above embodiments with an addition of various changes or by combining them with each other without departing from the scope of the present disclosure, and the present disclosure also includes such modifications.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

1 Control Device
3, 3A, 3B Accelerator Pedal
5A Depressing Speed Sensor
24 Reaction Force Setting Module
s Depression Amount
V Depressing Speed
f Reaction Force
F, FA, FB Control Map
F1, F1a, F1b Depression Characteristic
F2, F2a, F2b Counter-depression Characteristic

What is claimed is:

1. A vehicle control device, comprising:
a depression amount detector configured to detect a depression amount of an accelerator pedal;
a processor electrically connected to the depression amount detector and configured to execute a reaction force setting module to set a reaction force of the accelerator pedal based on a detection result of the depression amount detector;
a reaction force applying part electrically connected to the processor and configured to apply the reaction force to the accelerator pedal based on a setting result of the reaction force setting module; and
an operation amount detector electrically connected to the reaction force applying part and configured to detect an operation amount of a vehicle driver's foot on the accelerator pedal, wherein
the reaction force setting module sets a reaction force value of the accelerator pedal for a depression characteristic and a counter-depression characteristic, respectively, the depression characteristic being configured by a correlative relationship between the depression amount and the reaction force value of the accelerator pedal from a start of a depression operation of the accelerator pedal until an end of the depression operation, the counter-depression characteristic being configured by a correlative relationship between the depression amount and the reaction force value of the accelerator pedal from a start of a counter-depression operation of the accelerator pedal until an end of the counter-depression operation, and
the reaction force setting module includes a reaction force correcting module configured to reduce the reaction force value of the counter-depression characteristic as the operation amount detected by the operation amount detector increases.

2. The vehicle control device of claim 1, wherein the reaction force correcting module corrects the counter-depression characteristic by the reduction in the reaction force value.

3. The vehicle control device of claim 2, wherein the operation amount detector detects the operation amount of the driver's foot by using a depressing speed of the accelerator pedal as a parameter.

4. The vehicle control device of claim 1, wherein the operation amount detector detects the operation amount of the driver's foot by using a depressing speed of the accelerator pedal as a parameter.

5. The vehicle control device of claim 1, wherein the operation amount detector includes a contact pressure detector configured to detect a contact area of the driver's foot on the accelerator pedal, and detects the operation amount of the driver's foot by using the contact area as a parameter.

6. The vehicle control device of claim 2, wherein the operation amount detector includes a contact pressure detector configured to detect a contact area of the driver's foot on the accelerator pedal, and detects the operation amount of the driver's foot by using the contact area as a parameter.

7. A vehicle control device, comprising:
a processor configured to execute a reaction force setting module to set a reaction force value of an accelerator pedal based on a reference control map having a depression characteristic and a counter-depression characteristic and in which a correlative relationship between a depression amount of the accelerator pedal and the reaction force value is set; and
an operation amount detector configured to detect an operation amount of a vehicle driver's foot by using a depressing speed of the accelerator pedal as a parameter,
wherein the reaction force setting module changes the counter-depression characteristic of the reference control map in association with the depressing speed used by the operation amount detector.
